(19) United States
(12) Patent Application Publication
(10) Pub. No.: US 2016/0375535 A1
(43) Pub. Date: Dec. 29, 2016

(54) DRILLING METHOD FOR STRUCTURAL PARTS, AND COLLECTING ELEMENT FOR A DRILLING METHOD OF THIS KIND

(71) Applicant: Airbus Operations GmbH, Hamburg (DE)

(72) Inventors: Paul Joern, Hamburg (DE); Markus Mueller, Hamburg (DE)

(21) Appl. No.: 15/191,721

(22) Filed: Jun. 24, 2016

(30) Foreign Application Priority Data
Jun. 24, 2015 (DE) 102015211691.3

(51) Int. Cl. B23Q 11/00; B23B 45/00

(52) U.S. Cl. CPC B23Q 11/0071; B23B 45/003; B23B 2215/04; B23B 2226/275

(57) ABSTRACT

A drilling method for structural parts, in particular for carbon fiber composite structural parts, comprising the following method steps: providing a structural part and a collecting element; attaching the collecting element to a first side of the structural part opposite a drill point provided on a second side of the structural part, wherein a collecting portion of the collecting element is sealed off in a dust-tight manner from surroundings; drilling through the structural part from the second side of the structural part, at the drill point, using a drill, wherein the drill emerges from the structural part on the first side and enters the collecting portion of the collecting element, wherein drilling dust accumulating on the first side is collected by the collecting portion. A collecting element for a drilling method of this kind is disclosed.

### CROSS-REFERENCES TO RELATED APPLICATIONS

This application claims the benefit of the German patent application No. 10 2015 211 691.3 filed on Jun. 24, 2015, the entire disclosures of which are incorporated herein by way of reference.

### FIELD OF THE INVENTION

The present invention relates to a drilling method for structural parts, in particular for carbon fiber composite structural parts, and to a collecting element for a drilling method of this kind.

Although the present invention and the problem on which it is based can be applied to any desired structural parts, they will be described in more detail with respect to carbon fiber composite structural parts for aircraft or spacecraft.

### BACKGROUND OF THE INVENTION

Drilling produces what is known as drilling dust which, depending on the material and the drilling method, usually contains particles and/or chips of the removed or separated material.

Various designs exist for collecting the drilling dust that accumulates during drilling. For example, suction devices are placed on the entry side of the drill for this purpose, and the drilling dust is thus suctioned off. A suction device of this type is described, for example, in DE 103 14 038 A1.

Moreover, what are known as collecting bags also exist for collecting drilling dust, which bags are attached to the entry side of a drill. A collecting bag of this kind is described in DE 203 00 482 U1. The collecting bag is fixed to the wall to be drilled at a drill point. Then a drill is guided, on the entry side, first through the front face and then through a rear face of the collecting bag, to the drill point on the wall. Drilling dust emerging from the drill hole on the entry side of the drill is intended to be collected by the collecting bag.

During assembly for producing or maintaining an aircraft or a spacecraft, a plurality of through-holes have to be made in structural parts. These are, for example, through-holes through two structural parts that overlap and are already arranged in the installation position, and that are intended to be connected by means of a rivet connection.

In particular, when drilling carbon fiber composite structural parts that are made, at least in part, of carbon fiber-reinforced plastics material (CFRP), a drill dust is produced during drilling which contains, inter alia, carbon particles. When assembling structural parts, contamination of any components and of internal spaces of a structure with drilling dust of this kind is to be avoided. Up to now, components or internal spaces arranged in the vicinity of drilled holes have been extensively covered, in a complex manner, for example by means of protective films.

### SUMMARY OF THE INVENTION

One of the ideas of the present invention is therefore to provide an improved drilling method, in particular for through-holes.

The following is accordingly provided:
a drilling method for structural parts, in particular carbon fiber composite structural parts, comprising the following method steps: providing a structural part and a collecting element; attaching the collecting element to a first side of the structural part opposite a drill point provided on a second side of the structural part, wherein a collecting portion of the collecting element is sealed off in a dust-tight manner from surroundings of the structural part; drilling through the structural part from the second side of the structural part, at the drill point, using a drill, wherein the drill emerges from the structural part on the first side and enters the collecting portion of the collecting element, wherein drilling dust accumulating on the first side is collected in the collecting portion; and
a collecting element for a drilling method, in particular for a drilling method according to the invention, comprising: a fixing portion that is designed for attaching the collecting element to a structural part in a dust-tight manner; a collecting portion that is arranged for the purpose of introducing a drill from the side of the fixing portion and is designed for receiving drilling dust accumulating when a drill emerges from the structural part, wherein, in the assembled state, the fixing portion seals off the collecting portion in a dust-tight manner from the surroundings.

The concept on which the present invention is based comprises providing, on a first side of a structural component that is an emergence side of a through-hole, a collecting element that is attached to the side in a dust-tight manner and in which a drill emerging from the structural part enters. A collecting region of the collecting element is provided for receiving the drilling dust accumulating upon emergence from the structural part, which collecting region covers the emergence side of the through-hole and is sealed off in a dust-tight manner from surroundings by attaching the collecting element. When the drill enters the collecting portion from the side facing the first side of the structural part or from the side facing the fixing portion, the drilling dust accumulating upon emergence from the structural part is collected in the collecting portion. This advantageously prevents drilling dust from contaminating the surrounding components.

The drill point provided on the second side of the structural part is an entry point for the drill into the structural part. The second side of the structural part, on which the drill point is located, is therefore an entry side of the drilled hole.

The side of the collecting element facing away from the first side of the structural part or the side of the collecting element facing away from the fixing portion remains unpenetrated by the drill. Thus, drilling dust emerging on the first side of the structural part is completely collected inside the collecting portion and cannot escape.

A structural part is to be understood as any kind of structure that it is possible to drill through. This can, for example, be a single part of a structure, or a plurality of overlapping parts of a structure, or a composite made of parts of a structure.

Attaching the collecting element relative to the drill point is to be understood as meaning that a straight line through the drilling axis of a hole to be drilled extends through the collecting element. In the case of a drilled hole that is inclined relative to the structural part, this can therefore also be a correspondingly offset attachment of the collecting element.

In the present case, a drill is to be understood as any kind of tool that is suitable for drilling or for producing a hole. Apart from a conventional drill bit (twist drill), this can for example also be a different drill head, a milling tool, a cutting tool or the like.

In the present case, a drilling method is therefore to be understood as any kind of method, in particular any kind of separating method, by means of which a hole can be made in a structure.

It would furthermore be conceivable for a beam tool, e.g., a laser beam tool, to be used for drilling. In this case the beam, in particular the laser beam, would be understood as a drill. In this case, spatters or vapor occurring during drilling would be understood as drilling dust. In this case, the collecting element can additionally comprise an absorption and/or reflection portion.

The method according to the invention can be supplemented on the entry side of the drill by known designs for preventing dust contamination. For example, a suction device for suctioning drilling dust accumulating on the entry side can be provided on the second side of the structural part.

The drilling method can be supplemented after drilling by wiping the drill when withdrawing it from the collecting element. The drill can be wiped using either an edge of the drill entry hole in the collecting element, or a cleaning lip provided specifically for this purpose in the region of the collecting portion.

Moreover, the drilling method can be completed by detaching the collecting element from the first side of the structural part. For this purpose, a fixture provided between the collecting element and the structural part is released, and the collecting element including the drilling dust received therein is removed, in particular completely.

According to an advantageous aspect, a cavity is provided in the collecting portion, into which cavity the drill enters. In this case, drilling dust accumulating upon emergence on the first side of the structural part is collected in the cavity. For this purpose, a dust-binding medium is preferably provided inside the cavity, which medium binds the drilling dust. The cavity can, in addition, be a reservoir for the dust-binding medium. The dust-binding medium can, for example, be a gel, for example a highly adhesive gel, or a liquid, for example of a high viscosity. Moreover, in the case of a carbon fiber composite structural part, the medium may be a material that is the same or similar to the (uncured) matrix system of the structural part, which material, in particular, binds the carbon particles of the drilling dust well. As a result, the drilling dust is received, in particular bound, inside the cavity, and advantageously no drilling dust is released, in particular also when removing the collecting element from the first side of the structural part. The dust-binding medium does not necessarily completely fill the cavity. An intermediate space filled with air or another gas can also be provided between an entry point of the drill and the dust-binding medium inside the cavity. Accordingly, depending on the design of the collecting portion and the entry depth of the drill, when entering the cavity, the drill can either be plunged into the intermediate space alone, or also into the dust-binding medium.

According to a further aspect, by entering the collecting portion the drill creates a cavity, drilling dust accumulating on the first side being collected in the cavity. Advantageously, complex positioning work for precisely positioning a cavity is thus not necessary. Instead, the cavity is directly created on the required side during the drilling process. The cavity can be created, for example, in the form of a blind hole drilled in the material of the collecting portion by means of the drill. Other ways of creating a cavity are also conceivable. For example, a material structure that melts or degenerates under the effect of heat, for example a wax material structure, can be provided for this purpose in the collecting portion, with the result that a cavity is formed when the drill, which is hot from the friction of drilling, is plunged in. The material that is provided on the collecting portion, and in which the cavity is created, is preferably a dust-binding medium. As a result, the drilling dust is always received, in particular bound, inside the cavity, and advantageously no drilling dust is released, in particular also when removing the collecting element.

According to an aspect, the collecting element comprises a binding medium, in particular a foam, that is arranged on the collecting portion or forms the collecting portion. This is preferably a foam applied to an adhesive film. A different binding medium, for example a gel or the like, can also be applied to an adhesive film. Accordingly, first the adhesive film is applied and then the binding medium or the foam. The drill enters the binding medium or the foam at the collecting portion. A foam can advantageously be applied to the structural element, in particular to the adhesive film previously applied to the structural element, in a completely flexible manner, for example by means of an aerosol spray. Advantageously, the shape and size of the collecting element is thus not predetermined, but rather can be freely adapted in each case to the installation position and position of the drill points. For this purpose, the foam is formed of a material that adheres to the structural part and/or to the adhesive film. The foam can be designed to be drying and/or hardening, or can be designed to remain moist and/or flexible. In the case of a drying or hardening foam, the foam is formed by a material that is sufficiently strong and/or stiff so that the collecting element does not break or become detached when the drill enters. This may be what is known as polyurethane expanding foam, for example. It is furthermore conceivable for the foam to be provided in a hardened or dried form for drilling in the region in contact with surroundings, and to be provided in a soft or wet form for drilling in a region forming the collecting portion. By means of the adhesive film, it is possible to remove the foam in a simple manner by pulling off the adhesive film, in particular without leaving any residue. A cleaning step is thus advantageously avoided. The adhesive film can comprise a tear-off tab for this purpose. It would furthermore be conceivable to provide a second film that is applied to the first film prior to applying the binding medium or the foam. It would also be conceivable to apply the second film when the adhesive film and the binding medium or the foam are already applied to the first side of the structural part.

According to an aspect, a preloading element is provided in or on the collecting element. This is preferably a preloading element arranged between the first side of the structural part and the collecting portion. In this case, the dust-tight sealing of the collecting portion comprises preloading the preloading element, at least in portions. This can improve the dust-tightness and/or the quality in the region at which the drill emerges from the structural part. In this case, on account of the preload force, the collecting element is locally pressed against the first side of the structural part, which advantageously increases the dust-tightness. A further function of the preloading element comprises making it possible to advantageously prevent drill holes from fragmenting, delaminating or fraying at the exit thereof, in particular in the case of fiber composite materials such as are used in carbon fiber composite structural parts in the form of CFRP. Fraying is to be understood as a fiber coming out of the carbon fiber composite material without the fiber being separated. Delaminating is to be understood as layers in material composites, for example in carbon fiber composite materials, becoming detached. Fragmenting is to be understood as the formation of fragments, in particular at the emergence edge of the structural part. Fragmenting, delaminating or fraying of this kind can be particularly advantageously prevented by means of the preload force acting on the drill hole exit, since the preload force resists the forces from the drill that act locally on the structural part in the region where the drill emerges. As a result, the quality of the drill hole is increased on the emergence side in the region where the drill emerges from the structural part. The preloading element is particularly preferably arranged such that a preload force acts directly on the site at which the drill emerges from the structural part. If a cavity is present, the preloading element can be connected thereto or can form a portion that seals off the cavity. The preloading element can also be drilled through when the drill emerges from the structural part. Moreover, a prefabricated hole for the drill to pass through can also be provided in the preloading element. The preloading element can be produced, for example, in the form of a flexible portion, for example made of rubber. Alternatively, or in addition to a preloading element, an adhesive film can also be arranged between the first side of the structural part and the collecting portion, in order to increase the quality of the drill hole at the emergence side.

According to an aspect, dust-tight sealing of the collecting portion comprises adhesively bonding the collecting element to the first side of the structural part. Adhesive bonding is advantageously a method for fixing the collecting element that is particularly easy to implement. For example, a prefabricated adhesive layer can be provided on a fixing portion of the collecting element for this purpose. In order for it to be possible to easily remove the adhesively bonded collecting element from the structural part again after drilling, a tear-off tab that is left free of adhesive can be provided on the collecting element. Alternatively, or in addition, dust-tight sealing of the collecting portion comprises pressing the collecting element against the first side of the structural part. Pressing the collecting element against the first side of the structural part can fulfil a plurality of functions. In the case of adhesive bonding, pressing increases the loading capacity of the adhesive connection. Pressing can occur at a lateral and/or circumferential peripheral portion of the collecting element, for example. Moreover, the entire fixing portion of the collecting element can also be pressed on. If a preloading element is present, the preload force can be applied by means of the pressing. If a cavity is present, the pressing can generate a negative pressure inside the cavity that suctions the collecting element onto the first side of the structural part. This negative pressure can be used for fixing the collecting element onto the structural part. The negative pressure can also be used so that, when the drill enters the cavity, the drilling dust which has accumulated in the region at which the drill emerges from the structural part is suctioned into the cavity. The pressing can thus advantageously contribute to improved dust-tightness and improved collection of the drilling dust.

According to an aspect, the collecting element is designed to be resilient at least in portions, and the dust-tight sealing of the collecting portion comprises elastic deformation of the collecting element, at least in portions. The shape of the collecting element can thus be adapted to any shape of the first side of the structural part, and this advantageously improves the dust-tightness. In addition, it is thus advantageously possible to generate a negative pressure by resiliently compressing a cavity. Moreover, the resilient design makes it possible to integrate a preloading device into the collecting element. The collecting element can thus equalize different stress states of the preloading device. Furthermore, it would also be conceivable for a preloading device to be formed in one piece with the collecting element, i.e., as a resilient portion of the collecting element. Alternatively, or in addition, the collecting element is designed to be inflexible at least in portions, and the dust-tight sealing of the collecting portion comprises transferring a contact pressure force by means of the collecting element. Advantageously, a contact pressure force for attaching the collecting element can thus be applied particularly effectively by means of pressure on the collecting element. Optionally or in addition, an adhesive connection can also be provided. Moreover, if a cavity and/or a suction cavity is provided, optionally or in addition a negative pressure can also be applied for dust-tight fixing of the inflexible or solid collecting element.

According to an aspect, a suction cavity is provided on the side of the collecting element that faces the first side of the structural part. This is, in particular, a suction cavity provided in addition to the cavity in the collecting portion. It is also conceivable to design the cavity in the collecting portion as a suction cavity. The suction cavity can be designed in the form of a peripheral trench or a plunger for example. In this case, the dust-tight sealing of the collecting portion comprises generating a negative pressure inside the suction cavity that suctions the collecting element tightly onto the first side. Advantageously, as a result no additional fixing means are necessary. Rather, the collecting element can be fixed in a self-retaining manner to the first side of the structural element. In addition, further fixing means, in particular an adhesive, can also be provided for sealing the collecting portion. For example, the negative pressure in the suction cavity is generated by pressing the collecting element against the first side of the structural part. In this case, the negative pressure can be generated exclusively in the suction cavity. In addition, the negative pressure can also be generated in the cavity in the collecting portion. In this case, the suction cavity and the cavity in the collecting portion would preferably be interconnected. The fixing of the collecting element can be released in a simple manner by equalizing the negative pressure. If there is a suction cavity that is connected to the cavity in the collecting portion, the equalization occurs automatically when air enters through the entry hole when the drill enters. Alternatively, or in addition to a suction cavity, the collecting element comprises a magnet. In this case, the dust-tight sealing of the collecting portion comprises fixing the collecting element to the structural part by means of magnetic attraction. For this purpose, either a reverse polarity magnet can be provided on the structural part, or the structural part may be ferromagnetic, at least in portions, or be a structural part comprising a ferromagnetic insert. Advantageously, the collecting element can thus be fixed to the structural part without any force being required.

According to an aspect, the collecting element extends along the first side of the structural part in an elongate or planar manner opposite a plurality of drill points provided on the second side of the structural part. Particularly advantageously, operating steps for attaching individual collecting elements can thus be avoided. Instead, one common collecting element is provided for a plurality of drill points. This is advantageous, in particular, if a plurality of drill points is provided within a small surface area. In this case, the collecting portion can also extend along the first side in an elongate or planar manner, in particular continuously, opposite the plurality of drill points. This advantageously makes it possible to position the collecting element in a very uncomplicated manner, since only the collecting portion has to be located opposite the drill points, but it is not necessary to take into consideration the distribution of the individual drill points over the collecting portion. It would also be conceivable in this case to coat the entire structural component or a component part of the structural component with a collecting element comprising a continuous collecting portion. Moreover, a plurality of, in particular separate, collecting portions can also be provided, which portions are arranged opposite the drill points in each case. Advantageously, particularly reliable collection of the drilling dust is made possible in this case. For example, for this purpose a negative pressure and/or a dust-binding medium can be provided at every collecting portion independently of the other collecting portions. When the structural part is drilled through at the different drill points, the drill emerges from the structural part on the first side and enters the collecting portion opposite the drill point in each case.

According to an aspect of a collecting element, the fixing portion is designed to be self-retaining on the structural part. This is achieved, in particular, by means of an adhesive portion, and/or by means of a suction cavity that is designed to maintain a negative pressure that suctions the collecting element tightly onto a structural part, and/or by means of a magnet. In order for it to be possible easily remove the self-retaining collecting element again after drilling, a tear-off tab provided for this purpose can be provided on the collecting element.

According to an aspect of a collecting element, a cavity is provided in the collecting portion, which cavity is designed to collect accumulating drilling dust when a drill enters. In particular, a dust-binding medium provided inside the cavity is provided for this purpose.

According to a further aspect of the collecting element, a binding medium that is arranged on the collecting portion or forms the collecting portion, in particular a foam, preferably a foam applied to an adhesive film, is provided.

According to an aspect of the collecting element, the fixing portion and/or the collecting portion is resilient, at least in portions. The fixing portion and/or the collecting portion is accordingly resiliently deformable in order to seal off the collecting portion in a dust-tight manner. Alternatively, or in addition, the fixing portion and/or the collecting portion can be designed to be inflexible, at least in portions. Furthermore, alternatively or in addition, a preloading element is provided. In particular, the preloading element is arranged on the side of the collecting portion that faces the fixing portion. The preloading element can be preloaded in order to seal off the collecting portion in a dust-tight manner.

According to an aspect of the collecting element, the collecting portion is designed in an elongate or planar manner, in order to extend along a structural part opposite a plurality of drill points. Moreover, a plurality of collecting portions can also be provided in order to arrange the collecting portions opposite different drill points respectively along a structural part.

The aspect and developments above can, where appropriate, be combined with one another as desired. In particular, all the features and functions of the drilling method can also be applied to the collecting element, and vice versa. Further possible embodiments, developments and implementations of the invention also include not explicitly mentioned combinations of features of the invention which have been previously described or are described in the following with reference to the embodiments. In particular, in this case, a person skilled in the art will also add individual aspects as improvements or supplements to each basic form of the present invention.

### BRIEF DESCRIPTION OF THE DRAWINGS

The invention will be described in greater detail below on the basis of embodiments with reference to the accompanying figures of the drawings.

In the figures:

FIG. 1A shows a structural part and a collecting element prior to attachment;

FIG. 1B shows the collecting element according to FIG. 1A in a state in which it is attached to the structural part;

FIG. 1C shows the structural part and the collecting element according to FIG. 1B when being drilled through;

FIG. 1D shows the drilled-through structural part and the collecting element according to FIG. 1C comprising drilling dust collected in the collecting element;

FIG. 2 shows a drilled-through structural part and an embodiment of a collecting element while the drill is being withdrawn;

FIG. 3 shows an embodiment of a collecting element comprising a cleaning lip;

FIG. 4A shows an embodiment of a collecting element comprising a preloading element in a state when attached to a structural part and preloaded;

FIG. 4B shows the structural part and the collecting element according to FIG. 4A when being drilled through;

FIG. 4C shows the drilled-through structural part and the collecting element according to FIG. 4B, comprising drilling dust collected in the collecting element;

FIG. 5A shows an embodiment of a collecting element comprising a suction cavity;

FIG. 5B shows the collecting element according to FIG. 5A, in which a negative pressure is generated in the suction cavity;

FIG. 6 shows an embodiment of a collecting element comprising magnets;

FIG. 7 shows an embodiment of an inflexible collecting element;

FIG. 8 shows an embodiment of a collecting element comprising a peripheral portion;

FIG. 9 shows a development of the embodiment according to FIG. 8, comprising a tear-off tab;

FIG. 10 shows a development of the embodiment according to FIG. 8, comprising a preloading element;

FIG. 11 shows a development of the embodiment according to FIG. 10, comprising a hole prepared in the preloading element;

FIG. 12 shows an embodiment of a collecting element comprising a foam;

FIG. 13 shows a development of the collecting element according to FIG. 12, comprising a tear-off tab;

FIG. 14 shows a development of the embodiment according to FIG. 12, comprising a preloading element;

FIG. 15 shows an embodiment of an elongate collecting element comprising a continuous collecting portion;

FIG. 16 shows an embodiment of an elongate collecting element comprising a plurality of collecting portions;

FIG. 17 shows a further embodiment of an elongate collecting element comprising a plurality of collecting portions;

FIG. 18 shows another further embodiment of an elongate collecting element comprising a plurality of collecting portions; and

FIG. 19 shows a development of the embodiment according to FIG. 17.

The accompanying drawings are intended to provide further understanding of the embodiments of the invention. They illustrate embodiments and are used, in conjunction with the description, to explain principles and concepts of the invention. Other embodiments and many of the mentioned advantages are revealed in the drawings. The elements of the drawings are not necessarily shown true to scale in relation to one another.

In the figures, the same reference numerals denote like or functionally like components, unless stated otherwise.

### DETAILED DESCRIPTION OF THE PREFERRED EMBODIMENTS

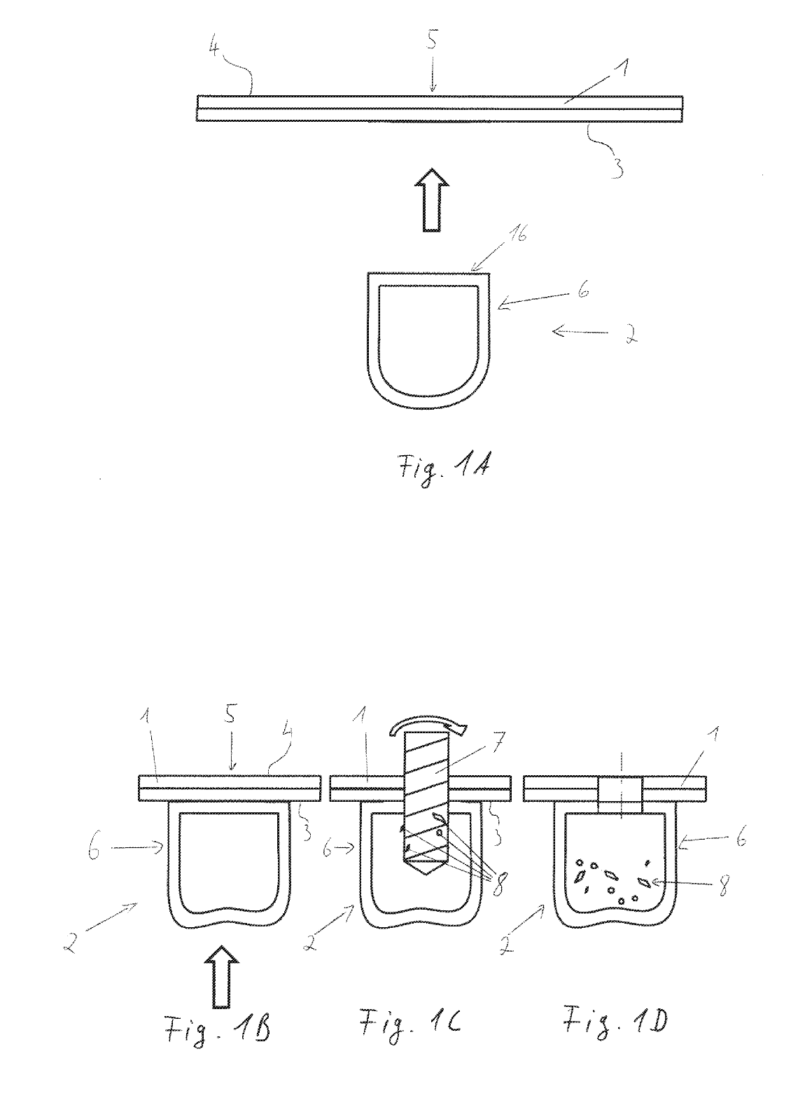

FIG. 1A shows a structural part 1 and a collecting element 2 prior to attachment.

The structural part 1 comprises two planar parts which are arranged in a lap joint and are intended to be drilled through together, for example in order to rivet the two planar parts to one another. At least one of the planar parts is a carbon fiber composite structural part that is made, at least in part, of carbon fiber reinforces plastics material (CFRP).

The structural part 1 comprises a first side 3 and a second side 4. A drill point 5 is provided on the second side 4 and defines the position at which a drill hole is to be located. In this case, the second side 4 is the entry side for a drill, while the first side 4 is an emergence side.

The collecting element 2 comprises a fixing portion 16 and a collecting portion 6. The fixing portion 16 is provided for attaching the collecting element 2 to the first side 3 of the structural part 1. The collecting portion 6 is provided for collecting drilling dust that accumulates on the first side 3 when a drill emerges from the structural part 1.

The arrow in the figures indicates that the collecting element 2 is attached to the first side 3 of the structural part 1, opposite the drill point 5. When attaching the collecting element 2 to the first side 3 of the structural part 1, the collecting portion 6 of the collecting element 2 is sealed off in a dust-tight manner from surroundings.

FIG. 1B shows the collecting element 2 according to FIG. 1A in a state in which it is attached to the structural part 1.

In this case, the collecting element 1 is attached to the first side 3 of the structural part 1, opposite the drill point 5. In order to attach the collecting element 2, a contact pressure force, indicated by the thick arrow, is applied to the collecting element 2, which force presses the collecting element 2 against the first side 3 of the structural part 1 such that the collecting portion 6 is sealed off in a dust-tight manner from the surroundings.

FIG. 1C shows the structural part and the collecting element according to FIG. 1B when being drilled through.

In order to drill through the structural part 1, a drill enters the structural part 1 from the second side 4 at the drill point 5 and completely drills through the structural part 1. Accordingly, the drill 7 emerges from the structural part 1 on the first side 3 and enters the collecting portion 6 on the side of the collecting portion 6 facing the fixing portion 16. In the process, drilling dust 8 that accumulates on the first side 3, when the drill 7 emerges from the structural part 1, is collected by the collecting element 2. Subsequently, the drill 7 can be withdrawn from the collecting element 2 and from the structural part 1 counter to the drilling direction.

FIG. 1D shows the drilled-through structural part 1 and the collecting element 2 according to FIG. 1C, comprising drilling dust 8 collected in the collecting element 2.

In the state shown, the drill 7 has already been removed again from the collecting element 2 and the structural part 1. In the process, the drilling dust 8 remains in the collecting portion 6 of the collecting element 2.

FIG. 2 shows a drilled-through structural part 1 and an embodiment of a collecting element 2 while the drill 7 is being withdrawn.

The collecting element 2 comprises a reservoir 9, in which a dust-binding medium 10 in the form of a liquid or a gel is provided. The dust-binding medium 10 binds the drilling dust 8.

Furthermore, when the drill 7 is withdrawn, drilling dust 8 initially adhering thereto is wiped off on the edge of the entry hole 18 of the drill 7 in the collecting element 2. Thus, drilling dust 8 initially adhering to the drill 7 also remains in the collecting element 2.

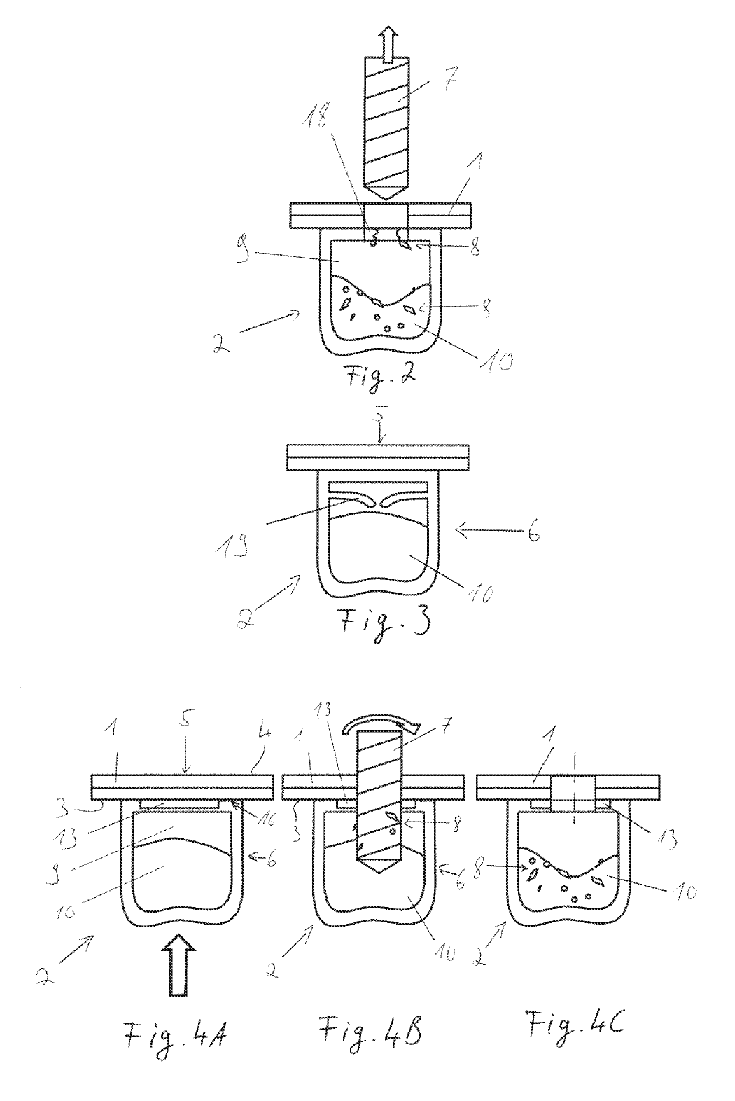

FIG. 3 shows an embodiment of a collecting element 2 comprising a cleaning lip 19. The collecting element 2 is shown in a state in which it is attached to the structural part 1, as in FIG. 1B, prior to drilling.

The cleaning lip 19 is arranged inside the collecting portion 6 of the collecting element 2 and is used to wipe off drilling dust adhering to a drill entering the collecting portion 6.

The cleaning lip 19 is arranged so as to be punctured by a drill 7 entering the collecting portion 6. For this purpose, the lip is preferably flexible and comprises a central opening so that only low forces act when the cleaning lip 19 is penetrated. Moreover, the cleaning lip 19 is arranged above the dust-binding medium 10. Therefore, when the drill 7 is withdrawn, the cleaning lip 19 wipes along the outside thereof and wipes off drilling dust 8 initially still adhering to the drill 7 while still inside the collecting portion 6. The drilling dust 8 that is wiped off thus remains inside the collecting portion 6.

FIG. 4A shows an embodiment of a collecting element 2 comprising a preloading element 13 in a state when attached to a structural part 1 and preloaded.

The preloading element 13 is arranged between the collecting portion 6 and the first side 3 of the structural part 1 on a side opposite the drill point 5. Moreover, the preloading element 13 is preloaded by means of a preload force (indicated by the thick arrow) that is applied to the collecting element 2. A preload force of the preloading element 13 thus acts locally on the location opposite the drill point 5. The preload force is thus applied in a region in which a drill 7 emerges from the structural part 1 when drilling through.

A cavity 9 is provided inside the collecting portion, which cavity is partly filled with a dust-binding medium 10.

FIG. 4B shows the structural part 1 and the collecting element 2 according to FIG. 4A when being drilled through.

A drill 7 drills through the structural part 1 from the second side 4 at the drill point 5, the drill 7 emerging from the structural part 1 and entering the collecting portion 6 in the region of the preloading element 13. When entering the collecting portion 6, the drill 7 drills through the preloading element 13 and the tip of the drill plunges into the dust-binding medium 10. In the process, drilling dust 8 that accumulates upon emergence from the structural part 1 is collected in the collecting portion 6.

On account of the preload thereof, the preloading element 13 ensures that the collecting portion 6 of the collecting element 2 also remains sealed off in a dust-tight manner from the surroundings in the drilled-through state.

In addition to the dust-tight attachment of the collecting element 2 to the first side 3 of the structural part 1, a further function of the preloading element comprises preventing fragmentation of the carbon fiber composite structural part by means of the preload force acting on the drill hole exit, and thus increasing the quality of the drill hole. For this purpose, the preloading element 13 is arranged directly at the location at which the drill 7 emerges from the structural part 1.

FIG. 4C shows the drilled-through structural part 1 and the collecting element 2 according to FIG. 4B, comprising drilling dust 8 collected in the collecting element 2.

In the state shown, the drill 7 has already been withdrawn from the collecting element 2.

The dust-binding medium 10 binds the drilling dust 8 collected in the collecting portion 6. Thus, the collecting element 2 can now be removed from the structural part 1 without drilling dust 8 being released in the process.

FIG. 5A shows an embodiment of a collecting element 2 comprising a suction cavity 14.

In this embodiment, the region of the suction cavity 14 forms the fixing portion 16. The collecting element 2 further comprises a preloading element 13 that can be preloaded by means of a suction force that occurs due to a negative pressure that can be generated in the suction cavity 14.

The suction cavity 14 is designed in the form of a trench surrounding the preloading element 13. Moreover, a connection is provided between a cavity 9 provided in the collecting region 6 and the suction cavity 14. A negative pressure can be generated inside the suction cavity 14 by pressing the collecting element 2 against the first side 3 of the structural part 1.

FIG. 5B shows the collecting element 2 according to FIG. 5A, in which a negative pressure is generated in the suction cavity 14.

The negative pressure is generated by means of a contact pressure force (indicated by the thick arrow) on the collecting element 2. The collecting element 2 is designed to be resilient and deforms accordingly on account of the contact pressure force. In the process, air is pressed out of the cavity 9 and out of the suction cavity 14. If the contact pressure force is released, a negative pressure occurs inside the cavity 9 and the suction cavity 14 on account of the restorative tendency of the resilient collecting element 2. The negative pressure thus present generates a suction force that pulls the collecting element 2 against the first side 3 of the structural part 1.

The contact pressure force initially applied in addition preloads the preloading element 13. When the contact pressure force is released, the preload of the preloading element 13 is maintained by means of the negative pressure prevailing in the suction cavity 14 and the suction pressure resulting therefrom.

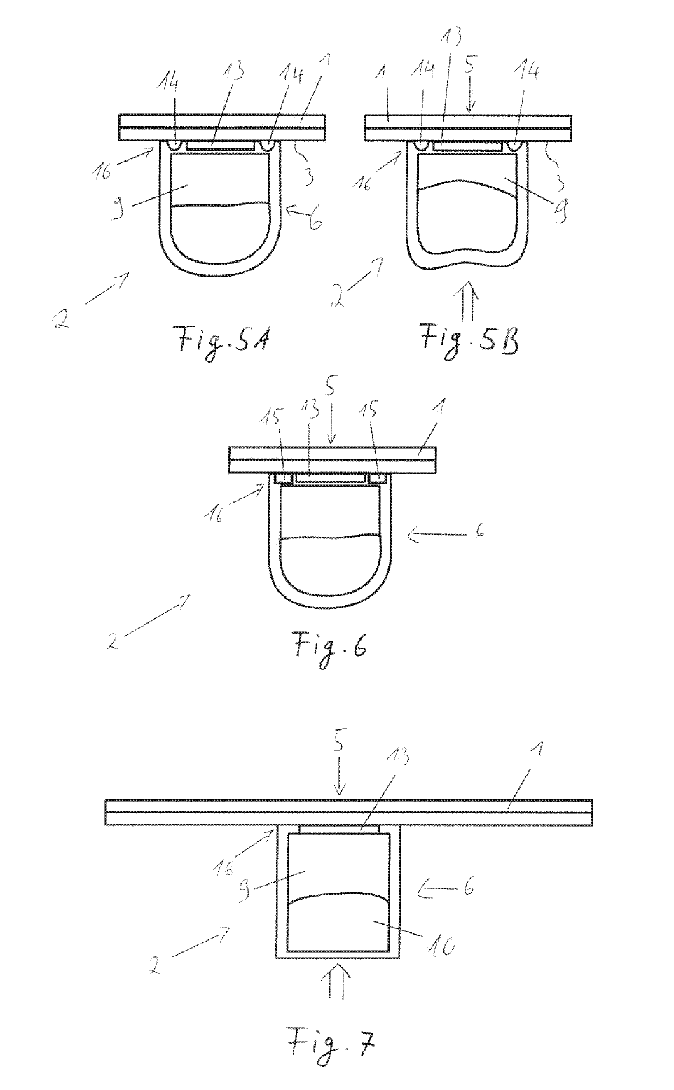

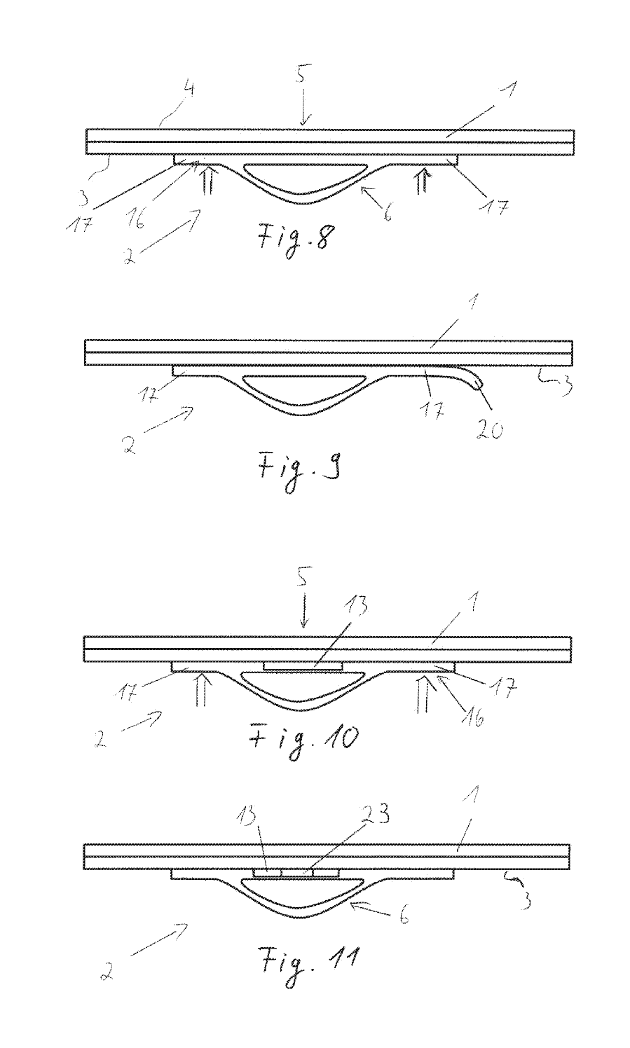

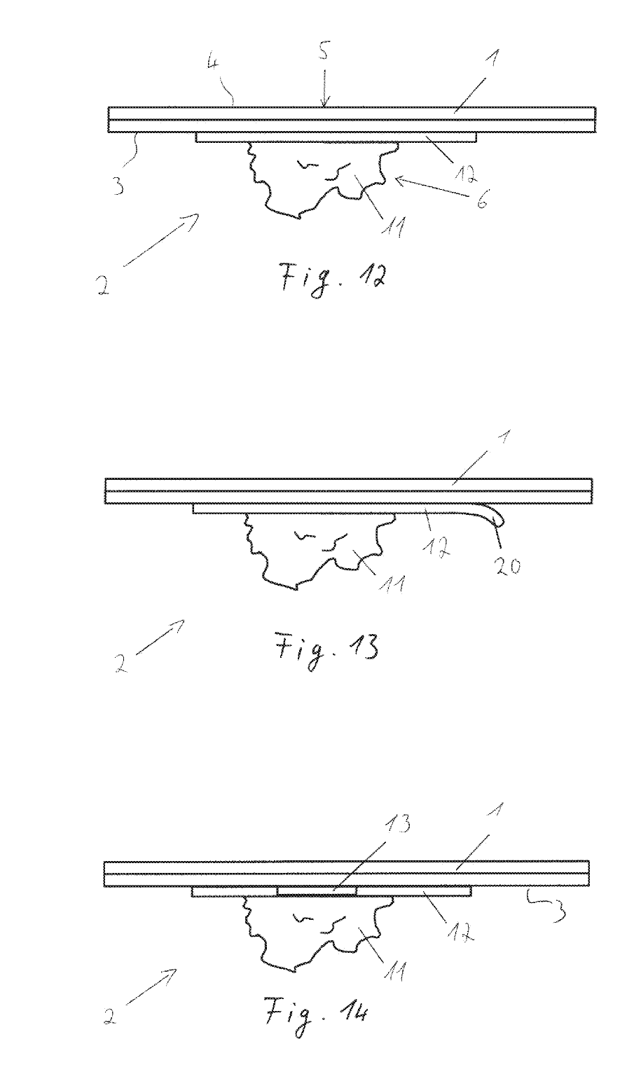

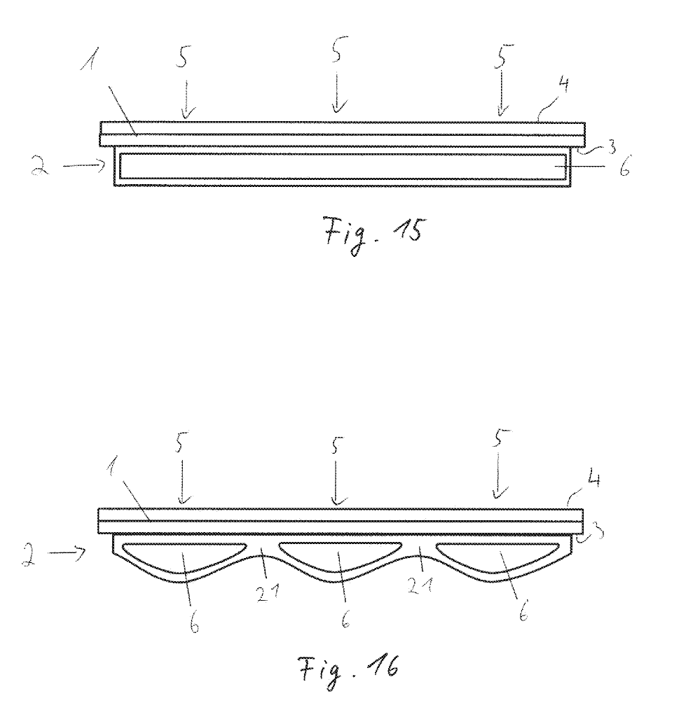

FIG. 6 shows an embodiment of a collecting element 2 comprising magnets 15.

A plurality of magnets 15 are provided, for example, which magnets are arranged so as to surround a preloading element 13. The region of the magnets 15 forms the fixing portion 16 of the collecting element 2. The preloading element 13 is preloaded by means of an attractive force generated using the magnets 15. On account of the magnetic attraction, no additional contact pressure force is required for preloading the preloading element 13.

In this embodiment, one of the two planar parts forming the structural part 1 preferably comprises a ferromagnetic material. This can, for example, be a fitting that is provided locally, for example what is known as a skin doubler, comprising a ferromagnetic metal. Skin doublers of this kind are provided, for example, on a door cutout of an aircraft or spacecraft or the like. The attractive force of the magnets can thus interact directly with the structural part. Alternatively, or in addition, a reverse polarity magnet can also be provided on the second side 4 of the structural part 1.

FIG. 7 shows an embodiment of an inflexible collecting element 2. In this embodiment, the collecting portion 6 and the fixing portion 16 are made of an inflexible material, for example a solid plastics material or a metal.

In this embodiment, in order to fix the inflexible collecting element 2 and in order to preload the preloading element 13, either just a contact pressure force can be provided, as indicated by the thick arrow, or an adhesive connection fixed by a contact pressure force can be provided.

In this embodiment, the preload force applied to the collecting element 2, for example on the side facing away from the structural part 1, is virtually entirely transferred to the fixing portion 16 on account of the inflexible design of the collecting element 2.

If there is a fixed adhesive connection, the contact pressure force can be released after preloading. Subsequently, the preloading element 13 is maintained in a preloaded state by means of the fixed adhesive connection.

FIG. 8 shows an embodiment of a collecting element 2 comprising a peripheral portion 17.

The peripheral portion 17 is provided on a resilient collecting element 2 and thus forms part of the fixing portion 16 thereof. The peripheral portion 17 protrudes laterally beyond the collecting portion 6. In order to attach the collecting element 2 in a dust-tight manner to the first side 3 of the structural part 1, a contact pressure force acting directly on the fixing portion 16 can thus be applied to the collecting element 2 in the region of the peripheral portion 17 despite the flexible design of the collecting element 2. The contact pressure force is indicated by the thick arrow.

As a result, a flexible collecting element 2 can also be attached to the first side 3 of the structural element 1 by means of an adhesive connection that is fixed at least locally, preferably all around, by a contact pressure force.

FIG. 9 shows a development of the embodiment according to FIG. 8, comprising a tear-off tab 20. The tear-off tab 20 is formed by a part of the peripheral portion 17 that is free of adhesive. The tab is used for removing the collecting element 2 from the first side 3 of the structural part 1 after the structural part 1 has been drilled through and the drill has been withdrawn.

In order to remove the collecting element, the tear-off tab 20 is gripped and the collecting element 2 is pulled off the first side 3 of the structural part 1. An adhesive connection is released in this manner, for example.

FIG. 10 shows a development of the embodiment according to FIG. 8, comprising a preloading element.

In this embodiment, in order to fix the flexible collecting element 2 and to preload the preloading element 13, a contact pressure force (indicated by the thick arrows) can be applied in the region of the peripheral portion 17, and an adhesive connection that is fixed by the contact pressure force can thus be provided. A fixed adhesive connection of this kind makes it possible to maintain the preload force of the preloading element 13 after the contact pressure force has been released.

FIG. 11 shows a development of the embodiment according to FIG. 10, comprising a hole 21 prepared in the preloading element 13.

The hole 21 functions as a passage for a drill to enter the collecting portion 6. The hole, in particular, makes it easier for a drill to penetrate the preloading element 13. As a result, an adhesive connection between the collecting element 2 and the first side 3 of the structural part 1, for example, can be designed to be less solid than in the embodiment according to FIG. 10.

FIG. 12 shows an embodiment of a collecting element 2 comprising a foam 11.

The foam 11 forms the collecting portion 6 and is applied to an adhesive film 12 applied to the first side 3 of the structural part 1. The adhesive film 12 is fixed to the first side 3 of the structural part 1 in a self-retaining, in particular adhesive, manner. The foam 11 is applied to the adhesive film 12 opposite a drill point 5 provided on the second side 4, for example by means of an aerosol spray, and adheres thereto by itself.

When drilling through the structural part 1, a drill enters the foam 11 after emerging from the structural part 1 on the first side 3. Drilling dust accumulating on the first side is thus collected in the foam 11. After the drill has been withdrawn, the collecting element 2 including the foam 11 can be completely removed from the first side 3 of the structural part 1 in a simple manner by releasing the adhesive film 12.

The shape and size of the collecting element, in particular of the collecting portion 6 formed by the foam 11, is not predetermined, but rather can be freely adapted in each case to the installation position of the structural part 1. The foam is formed by a material that is sufficiently strong and/or stiff so that the collecting element 2 does not break or become detached when the drill enters. This is what is known as polyurethane expanding foam, for example.

FIG. 13 shows a development of the collecting element 2 according to FIG. 12, comprising a tear-off tab.

The tear-off tab 20 is formed by a part of the adhesive film 12 that is free of adhesive. The tab is used for removing the collecting element 2 from the first side 3 of the structural part 1 after the structural part 1 has been drilled through and the drill has been withdrawn. In this case, the adhesive connection is released and thus the adhesive film 12 together with the foam 11 and the drilling dust received therein is removed by gripping the tear-off tab 20 and pulling the adhesive film 12 off the first side 3 of the structural part 1.

FIG. 14 shows a development of the embodiment according to FIG. 12, comprising a preloading element 13.

In this embodiment, a contact pressure force that preloads the preloading element 13 can be applied to the adhesive film 12 before the foam 11 is applied. For example, in addition the adhesive film can be sufficiently adhesive and solid that is able to maintain a preload force of the preloading element 13.

It would also be conceivable to firstly place the adhesive film 12 on a planar base prior to attachment and without adhering the film to the base, to then apply the foam 11 to the adhesive film and allow the foam to harden, and finally, when attaching the collecting element 2 to the first side 3 of the structural part 1, to apply a contact pressure force to the hardened foam from the outside, which force preloads the preloading element 13.

FIG. 15 shows an embodiment of an elongate collecting element 2 comprising a continuous collecting portion 6.

The collecting element 2 extends along the first side 3 of the structural part 1 in an elongate manner opposite a plurality of drill points 5 provided on the second side 4 of the structural part 1.

The collecting portion 6 is also elongate and extends continuously along the first side 3 of the structural part 1, opposite the plurality of drill points 5. When drilling through the structural part at the different drill points 5, the drill 7 thus always enters the collecting portion 6, and drilling dust accumulating on the first side is collected in the collecting portion 6.

In this embodiment, the collecting element 2 is preferably designed to be solid, i.e., inflexible, and is pressed against the first side 3 of the structural part 1 by means of a contact pressure force (not shown) in such a way that the collecting portion 6 is sealed off in a dust-tight manner from the surroundings.

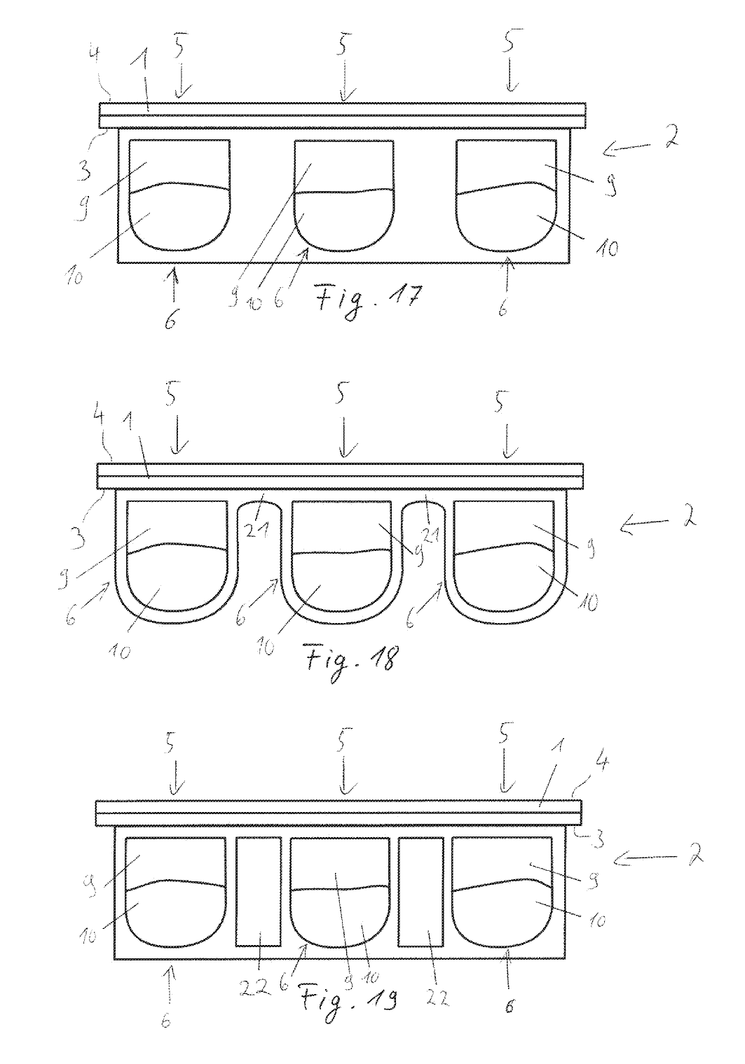

FIG. 16 shows an embodiment of an elongate collecting element 2 comprising a plurality of collecting portions 6.

In this case, too, the collecting element 2 extends along the first side 3 of the structural part 1 in an elongate manner opposite a plurality of drill points 5 provided on the second side 4 of the structural part 1. A plurality of collecting portions 6 is provided, which portions are arranged opposite the drill points 5 in each case. When drilling through the structural part 1 at the different drill points 5, the drill always enters the collecting portion 6 opposite the drill point 5 in question.

In this embodiment, the collecting element 2 is designed so as to be resilient. Intermediate portions 21 are provided between the separate collecting portions in each case. In a similar manner to the case of the peripheral portions 17 in the embodiment according to FIGS. 8 to 12, a contact pressure force for attaching the collecting element 2 in a dust-tight manner to the first side 3 of the structural part 1 can be applied at the intermediate portions 21 despite the resilient design of the collecting element 2.

In addition, peripheral portions 17 (not shown) can additionally also be provided here.

FIG. 17 shows a further embodiment of an elongate collecting element 2 comprising a plurality of collecting portions 6.

In this case, too, the collecting element 2 extends along the first side 3 of the structural part 1 in an elongate manner opposite a plurality of drill points 5 provided on the second side 4 of the structural part 1. In addition, a plurality of collecting portions 6 arranged opposite the drill points 5 in each case is also provided here. In this embodiment, the collecting portions 6 each comprise a cavity 9 in which a dust-binding medium 10 is provided.

In this embodiment, the collecting element 2 is preferably designed to be inflexible, and is pressed against the first side 3 of the structural part 1 by means of a contact pressure force (not shown) in such a way that each of the collecting portions 6 is sealed off in a dust-tight manner from the surroundings.

FIG. 18 shows another further embodiment of an elongate collecting element 2 comprising a plurality of collecting portions.

In a similar manner to the embodiment according to FIG. 17, this is a collecting element 2 comprising collecting portions that are arranged opposite drill points 5 and each comprise a cavity 9 in which a dust-binding medium 10 is provided.

Here, however, the collecting element 2 is designed to be resilient, unlike in the embodiment according to FIG. 17. Intermediate portions 21 are provided between the separate collecting portions in each case. In a similar manner to the embodiment according to FIG. 16, a contact pressure force (not shown, for the purpose of improved clarity) for attaching the collecting element 2 in a dust-tight manner to the first side 3 of the structural part 1 can be applied at the intermediate portions despite the resilient design of the collecting element 2.

FIG. 19 shows a development of the embodiment according to FIG. 17.

In addition to the features described with reference to FIG. 17, this embodiment comprises hollow spaces 22 provided between the separate collecting portions 6. The hollow spaces reduce the weight of the collecting element 2, which makes handling easier. Moreover, the hollow spaces 22 reduce the amount of material used when producing the collecting element 2. Furthermore, the additional hollow spaces 22 can optionally function as additional collecting portions, for example at places in which only chips accumulate and thus a medium that binds the drilling dust is not required.

Although the present invention has been described on the basis of preferred embodiments, it is not restricted to the embodiments, but rather can be modified in various ways.

For example, different ways of fixing the collecting element can be combined.

Furthermore, it is also conceivable, in particular in the case of an elongate or planar collecting element, to provide the collecting element so as to be resilient in portions and inflexible in portions. The collecting element can be provided in a manner adapted to the contour of the structural part such that, for example, the collecting element is provided in a flexible manner on flat portions of the structural part in order to better apply a preload force, and a resilient portion of the collecting element is provided at bends in the contour of the structural part in order to adapt to the contour of the bend.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

The embodiments were chosen and described in order to best explain the principles of the invention and its practical applications, to thereby enable others skilled in the art to best utilize the invention and various embodiments with various modifications as are suited to the particular use contemplated. In the appended claims and throughout the specification, the terms “including” and “in which” are used as the plain-English equivalents of the respective terms “comprising” and “wherein,” respectively. Furthermore, “a” or “one” does not exclude a plurality in the present case.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A drilling method for structural parts, comprising the following method steps:
providing a structural part and a collecting element;
attaching the collecting element to a first side of the structural part opposite a drill point provided on a second side of the structural part, wherein a collecting portion of the collecting element is sealed off in a dust-tight manner from the surroundings of the structural part; and
drilling through the structural part from the second side of the structural part, at the drill point, using a drill,
wherein the drill emerges from the structural part on the first side and enters the collecting portion of the collecting element, and
wherein drilling dust accumulating on the first side is collected in the collecting portion.

2. The drilling method according to claim 1, wherein a cavity is provided in the collecting portion, into which cavity the drill enters, drilling dust accumulating on the first side being collected in the cavity, in a dust-binding medium provided inside the cavity.

3. The drilling method according to claim 1, wherein by entering the collecting portion the drill creates a cavity in a dust-binding medium provided on the collecting portion, drilling dust accumulating on the first side being collected in the cavity.

4. The drilling method according to claim 1, wherein the collecting element comprises a binding medium that is arranged on the collecting portion or forms the collecting portion, and the drill enters the binding medium at the collecting portion.

5. The drilling method according to claim 1, wherein the collecting element comprises a binding medium in the form of a foam that is arranged on the collecting portion or forms the collecting portion, and the drill enters the binding medium at the collecting portion.

6. The drilling method according to claim 1, wherein the collecting element comprises a binding medium, in the form of a foam applied to an adhesive film, that is arranged on the collecting portion or forms the collecting portion, and the drill enters the binding medium at the collecting portion.

7. The drilling method according to claim 1, wherein a preloading element is provided in or on the collecting element between the first side of the structural part and the collecting portion, the dust-tight sealing of the collecting portion comprising preloading the preloading element at least in portions to improve at least one of the dust-tightness and the quality in the region at which the drill emerges from the structural part.

8. The drilling method according to claim 1, wherein the dust-tight sealing of the collecting portion comprises at least one of adhesively bonding and pressing the collecting element against the first side of the structural part, at at least one of a lateral and circumferential peripheral portion of the collecting element.

9. The drilling method according to claim 1, wherein at least one of
the collecting element is configured to be resilient at least in portions, and the dust-tight sealing of the collecting portion comprises elastic deformation of the collecting element, at least in portions, and
the collecting element is configured to be inflexible at least in portions, and the dust-tight sealing of the collecting portion comprises transferring a contact pressure force via the collecting element.

10. The drilling method according to claim 1, wherein at least one of
a suction cavity is provided on the side of the collecting element that faces the first side of the structural part and the dust-tight sealing of the collecting portion comprises generating a negative pressure inside the suction cavity that suctions the collecting element tightly onto the first side, and
the collecting element comprises a magnet, the dust-tight sealing of the collecting portion comprising fixing the collecting element to the structural part by means of magnetic attraction.

11. The drilling method according to claim 1, wherein one of
the collecting element extends along the first side of the structural part in an elongate or planar manner opposite a plurality of drill points provided on the second side of the structural part, the collecting portion also extending in an elongate or planar manner opposite the plurality of drill points, or
a plurality of collecting portions is provided, which portions are arranged opposite the drill points in each case,
the drill emerging from the structural part on the first side and entering the collecting portion opposite the drill point in each case when the structural part is drilled through at the different drill points.

12. A collecting element for a drilling method, comprising:
a fixing portion configured to attach the collecting element to a first side of a structural part opposite a drill point on a second side of the structural part in a dust-tight manner;
a collecting portion attached to the fixing portion and arranged for the introduction of a drill from the side of the fixing portion and configured to receive drilling dust accumulating when a drill emerges from the structural part,
wherein, in the assembled state, the fixing portion seals off the collecting portion in a dust-tight manner from the surroundings.

13. The collecting element according to claim 12, wherein the fixing portion is configured to be self-retaining on the structural part, and comprises at least one of
an adhesive portion,
a suction cavity that configured to maintain a negative pressure that suctions the collecting element tightly onto the structural part, and
a magnet.

14. The collecting element according to claim 12, wherein a cavity is provided in the collecting portion, the cavity being configured to collect accumulating drilling dust when a drill enters.

15. The collecting element according to claim 14, wherein a dust-binding medium is provided inside the cavity.

16. The collecting element according to claim 12, wherein a binding medium, comprising at least one of
a foam, and
a foam applied to an adhesive film,
is provided, which binding medium is arranged on the collecting portion or forms the collecting portion.

17. The collecting element according to claim 12, wherein at least one of
the fixing element and
the collecting portion
is configured to be resilient, at least in portions, and is elastically deformable for dust-tight sealing of the collecting portion.

18. The collecting element according to claim 12, wherein a preloading element is provided, on the side of the collecting portion facing the fixing portion, which element is configured to be preloaded for dust-tight sealing of the collecting portion.

19. The collecting element according to claim 12, wherein the collecting portion is configured in an elongate or planar manner, in order to extend along a structural part opposite a plurality of drill points along the structural part.

20. The collecting element according to claim 12, wherein a plurality of collecting portions is provided to arrange the collecting portions opposite different drill points respectively along the structural part.
